(19) United States
(12) Patent Application Publication
(10) Pub. No.: US 2015/0116157 A1
(43) Pub. Date: Apr. 30, 2015

(54) ANTENNA CASE OF AIR-HOLE STRUCTURE

(71) Applicant: Jinyoung PARK, Seoul (KR)

(72) Inventor: Jinyoung PARK, Seoul (KR)

(21) Appl. No.: 14/063,486

(22) Filed: Oct. 25, 2013

(51) Int. Cl. H01Q 1/24

(52) U.S. Cl. CPC H01Q 1/24
USPC 343/702

(57) ABSTRACT

The antenna case with an air hole structure has excellent durability while lightweight and has improved electric characteristics of radio waves emitted from an antenna. The antenna case having the air hole structure includes a main body having a plurality of air holes and a pair of caps. The main body is formed into a tube shape to have the air hole structure, and both distal ends of the main body are opened. The pair of caps covers both opened portions of the main body, and includes an upper cap and a lower cap. The plurality of air holes formed in an internal portion of the main body reduce a weight of the main body, and improve electric characteristics of radio waves due to a dielectric constant of a resin. A conductor rod is inserted into the air holes, thereby improving a pattern of radio waves emitted from the antenna.

### BACKGROUND

1. Field of the Invention

The present invention relates to an antenna assembly case which constitutes a base station and a repeater for mobile communication, and more particularly, to an antenna case having an air hole structure formed in an internal portion of a main body of the antenna case.

2. Discussion of Related Art

Due to the universalization of personal mobile phones and recent increase in the prevalence of smart phones and tablet PCs, an amount of use of radio waves for calls and wireless Internet has rapidly increased. Needs of customers who want to use phones and Internet anytime and anywhere and customer's complaints about communication speed and call quality are increasing day by day. A shadow area in which radio waves are not transferred well is generated not only indoors such as in a building, but also outdoors due to a long distance from an existing base station and repeater for mobile communication or terrain features, and therefore communication carriers are additionally installing base stations and repeaters for mobile communication in such shadows area in order to relieve the needs and complaints of the customers.

The base station and the repeater for mobile communication include an antenna that is a radio wave transmission and reception device and an antenna case that provides an installation space for the antenna and protects the antenna. In particular, the antenna case protects the antenna built therein, is suitable for characteristics of the antenna, and maintains directivity of the emitted radio waves. In addition, in the antenna case, changes in electric characteristics of radio waves such as a beam width deviation of the antenna, an amount of change in a standing wave ratio, and the like should be reduced.

Meanwhile, the antenna case used in the conventional base station and repeater for mobile communication is made of a synthetic resin such as acrylonitrile-butadiene-styrene (ABS), acrylonitrile-styrene-acrylate (ASA), a fiber-reinforced plastic (FRP), or the like, and has a three-dimensional (3D) pole-shaped structure. The antenna case is formed in such a manner that a single synthetic resin is subjected to extrusion molding to have a constant thickness (3.5 to 5 mm), or formed to have a double extrusion structure in which other resins are additionally used in order to improve durability of the antenna case.

A weight of the antenna case is changed depending on a width, an area, and a thickness of the antenna case. When the thickness of the antenna case is increased in order to protect the antenna, the antenna case is difficult to install and vulnerable to wind due to its increased weight, and electric characteristics of radio waves deteriorate, causing a standing wave ratio to be changed due to a thickness of the synthetic resin having a dielectric constant or a difference of a beam width to occur.

On the other hand, when the thickness of the antenna case is reduced, a deflection phenomenon in which a shape of the antenna case is not properly formed may occur, or a problem may occur in the durability of the antenna case due to an external temperature or the like. When the antenna case is manufactured to have the double extrusion structure in order to improve the durability of the antenna case, the weight of the antenna case is increased, and the electric characteristics of radio waves deteriorate due to a dielectric constant of the synthetic resin.

### SUMMARY OF THE INVENTION

The present invention is directed to an antenna case having an air hole structure which is excellent in durability while being lightweight.

In addition, the present invention is directed to an antenna case having an air hole structure which improves electric performance of radio waves emitted from an antenna by improving a structure of the antenna case.

In addition, the present invention is directed to an antenna case having an air hole structure in which an air hole structure is formed in an internal portion of a main body of the antenna case so that the antenna case has excellent durability while being lightweight, and electric characteristics of radio waves emitted from an antenna are improved.

According to an aspect of the present invention, there is provided an antenna case having an air hole structure including: a main body and a pair of cap members. The main body may be formed into a tube shape to provide an installation space in which a radio wave transmission and reception device is installed, both distal ends of the main body may be opened, and the main body may include a plurality of tubular air holes formed therein. Here, the pair of cap members may cover both opened portions of the main body.

In addition, the air holes may be formed so as to correspond in a direction connecting both of the opened portions of the main body.

In addition, the main body may be made of at least one synthetic resin, and be subjected to extrusion molding so as to form a structure of the plurality of air holes.

In addition, the antenna case may further include at least one conductor rod. Here, the conductor rod may be inserted into at least one of the plurality of air holes.

In addition, the conductor rod may be inserted into the air hole positioned in a rear surface portion, a side surface portion, or a front surface portion of the radio wave transmission and reception device.

According to the present invention, durability of the main body may be improved by the structure of the plurality of air holes formed in the internal portion of the main body, and maintenance and repair of a base station and a repeater for mobile communication may be facilitated by reducing a weight of the main body. In addition, the antenna case having the air hole structure may be made of a single material to reduce a unit price of a product, thereby improving productivity of the product.

In addition, the air hole structure may improve transformation of radio waves due to a dielectric constant of the synthetic resin used as a material of the main body, thereby improving electric characteristics of the radio waves.

In addition, by inserting the conductor rod into the air hole positioned in the front surface portion, the side surface portion, or the rear surface portion of the radio wave transmission and reception device, a beam width of the radio waves may be improved, and a front-to-back ratio, isolation, and a radiation pattern may be adjusted.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view showing an antenna case having an air hole structure according to an embodiment of the present invention;

FIG. 2 is an exploded view showing the antenna case having the air hole structure of FIG. 1;

FIG. 3 is a cross-sectional view showing the antenna case having the air hole structure of FIG. 1;

FIG. 4A is a side view showing an example in which an external side of a cap member and a supporter are connected so that an antenna case having an air hole structure according to an embodiment of the present invention is fixed to a wall body;

FIG. 4B is a perspective view showing an internal side in which a supporter is connected to a cap member so that an antenna is installed inside an antenna case having an air hole structure according to an embodiment of the present invention;

FIG. 5 is a perspective view showing an example in which a conductor rod is inserted into an air hole positioned in a front surface portion of a main body of an antenna case having an air hole structure according to another embodiment of the present invention;

FIG. 6 is a perspective view showing an example in which a conductor rod is inserted into an air hole positioned in a rear surface portion of a main body of an antenna case having an air hole structure according to still another embodiment of the present invention;

FIG. 7 is a perspective view showing an example in which a conductor rod is inserted into an air hole positioned in a side surface portion of a main body of an antenna case having an air hole structure according to yet another embodiment of the present invention;

FIG. 8 is a graph showing a pattern of radio waves which are measured when using an antenna case used in a conventional repeater for mobile communication;

FIG. 9 is a graph showing a pattern of radio waves which are measured when using an antenna case having an air hole structure according to an embodiment of the present invention;

FIG. 10 is a graph showing a standing wave ratio of radio waves which are measured without covering an antenna case;

FIG. 11 is a graph showing a standing wave ratio of radio waves which are measured when using a conventional antenna case; and

FIG. 12 is a graph showing a standing wave ratio of radio waves which are measured when using an antenna case having an air hole structure according to an embodiment of the present invention.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Hereinafter, embodiments of the present invention will be described in detail with reference to the accompanying drawings.

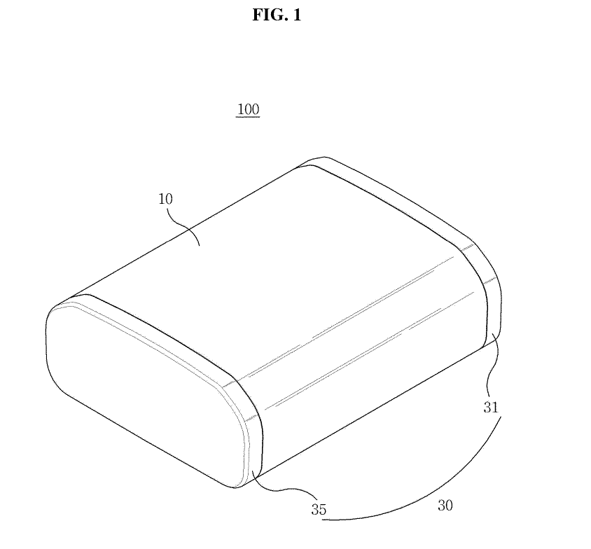

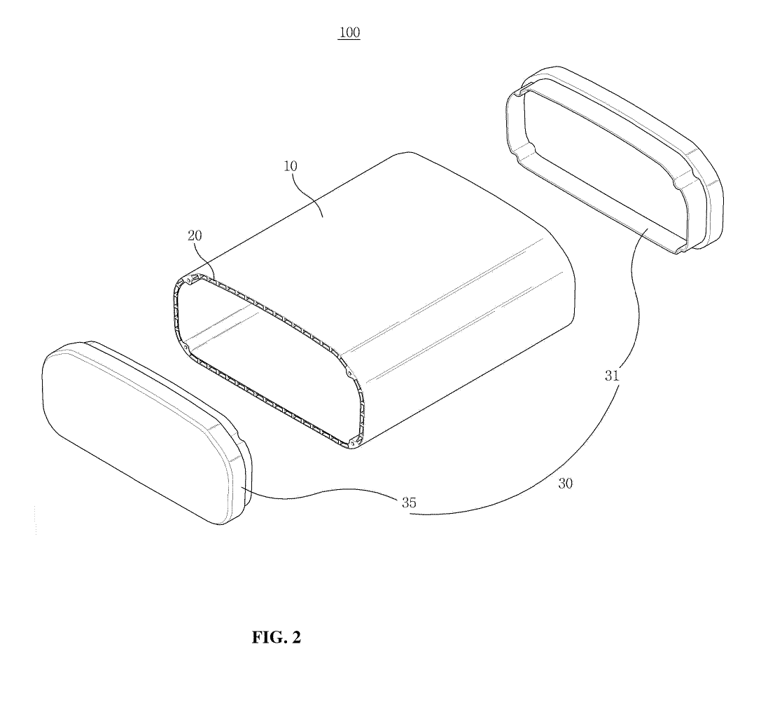

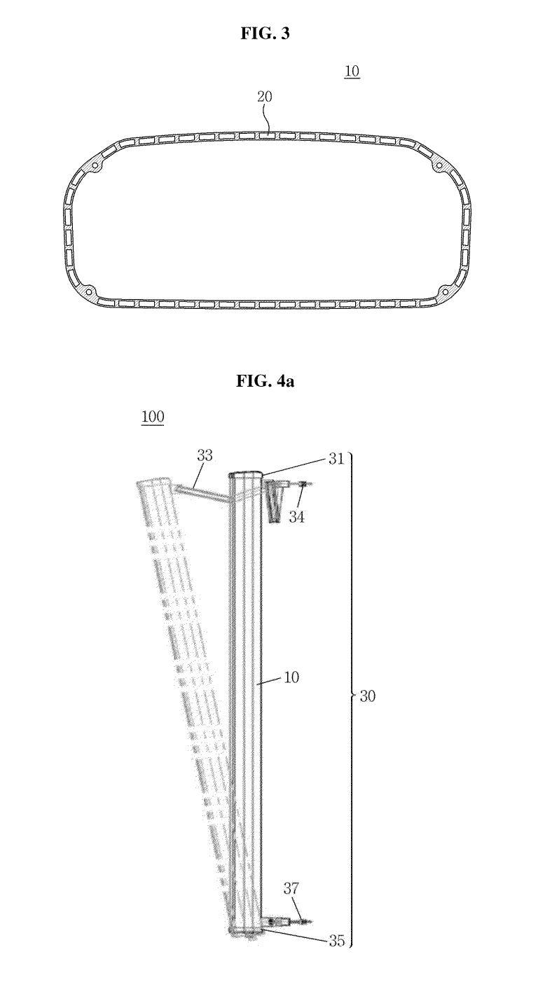

FIG. 1 is a perspective view showing an antenna case 100 having an air hole structure according to an embodiment of the present invention, FIG. 2 is an exploded view showing the antenna case 100 having the air hole structure of FIG. 1, and FIG. 3 is a cross-sectional view showing the antenna case 100 having the air hole structure of FIG. 1.

Referring to FIGS. 1 to 3, the antenna case 100 having the air hole structure according to an embodiment of the present invention is an antenna case for protecting a radio wave transmission and reception device, and includes a main body 10 which has a plurality of air holes 20 formed therein and whose both distal ends are opened, and a pair of cap members 30 which are each mounted in an end of the main body 10 to cover opened portions of the main body 10.

Hereinafter, each component of the antenna case 100 having the air hole structure according to the present embodiment will be described.

The main body 10 is formed in a tube shape to provide an installation space in which a radio wave transmission and reception device is installed, both of the distal ends of the main body are opened, and the main body 10 has the plurality of air holes 20 formed therein. Both of the distal ends of the main body 10 are opened so as to be fastened to the pair of cap members 30. The plurality of air holes 20 are formed as an internal structure of the main body 10, and made of at least one synthetic resin to be subjected to extrusion molding. The synthetic resin used as a material of the main body 10 is acrylonitrile-styrene-acrylate (ASA) which has excellent impact resistance, weather resistance, and ultraviolet resistance, and significantly smaller degradation of characteristics and change in appearance of a molded article than acrylonitrile-butadiene-styrene (ABS) even when used outdoors for a long period of time. In addition, characteristics of ASA such as tensile strength, bending strength, a flexural modulus, and the like are not inferior to those of ABS, and a heat distortion temperature of ASA is 83° C. which is similar to that of semi-resistant ABS. Since ASA contains styrene, ASA is sufficient as an electrical insulation material because it is significantly high in volume specific resistance and dielectric breakdown voltage. In addition, ASA has excellent electric characteristics because its dielectric constant and frequency dependency are low. Thus, when ASA is used, there are advantages in that a durability problem caused by outdoor use is solved and electric characteristics of radio waves are improved. In addition, ASA has balanced physical properties balance and all of the moldability required of any plastic, and therefore various patterns such as a circle, a wave, a square, and the like can be designed on an outer surface of the main body 10, thereby improving indoor and outdoor aesthetics. In addition, a structure of the air holes 20 using a plurality of synthetic resins may be possible. Meanwhile, a structure of the main body 10 is not limited, and the main body 10 may have various shapes. As an external structure of the main body 10 according to an embodiment of the present invention, a front surface portion may be processed to have a convex shape in a direction of radiation of an antenna built therein and a rear surface portion may be processed to have the form of a plane.

The plurality of air holes 20 are formed in an internal portion of the main body 10. The air holes 20 are provided in the internal portion of the main body 10 in the form of tubular holes in a longitudinal direction of the main body 10 rather than holes penetrating outer and inner surfaces of the main body 10. In addition, the air holes 20 are processed so that the cap member 30 can be fastened to the main body 10. As shown in FIG. 3, the air holes 20 corresponding to edges of the main body 10 may be processed to have circular shapes. A rod or holes are processed or bolts are used so that the cap member 30 can be fastened to a position corresponding to the circular air holes 20. Meanwhile, the air holes 20 allow the main body 10 to be lightweight, so that the repeater for mobile communication may be easily installed. When a weight of the antenna case in the related art is reduced, a deflection phenomenon frequently occurs, but the structure of the air holes 20 improves rigidity of the main body 10. In the conventional antenna case, transformation of radio waves occurs due to a dielectric constant of a resin used as a material of the main body, but in the antenna case 100 having the air hole structure according to an embodiment of the present invention, an internal structure of the main body 10 forms a cavity as the structure of the air holes to reduce a dielectric constant relative to the thickness, thereby improving electric characteristics of radio waves.

The pair of cap members 30 cover both tubular cross sections of the main body 10 which are opened. In the cap members 30, grooves or holes may be formed with sizes corresponding to the opened distal ends of the main body 10 so that the cap members 30 can be fastened to the opened distal ends of the main body 10.

The cap members 30 include an upper cap 31 and a lower cap which form a pair. The cap members 30 may allow the radio wave transmission and reception device to be installed inside the main body 10, and a fastening groove or hole to which a supporter is connected is provided in the cap members 30 so that the antenna case 100 having the air hole structure can be installed.

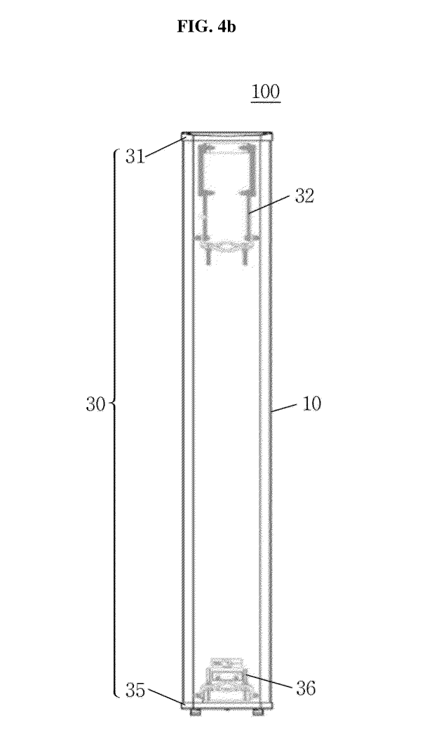

For example, in FIG. 4A, a side view showing an example in which an external portion of the cap member 30 is connected to the supporter in order to fix the antenna case 100 having the air hole structure according to an embodiment of the present invention to a wall body is illustrated. FIG. 4B is a perspective view showing an internal side in which a supporter is connected to the cap member 30 so that an antenna is installed inside the antenna case 100 having an air hole structure according to an embodiment of the present invention.

Referring to FIG. 4B, a groove or a hole for enabling an antenna that is the radio wave transmission and reception device to be mounted inside the main body is processed in an inner surface of the cap member 30, so that upper and lower cap internal antenna supporters 32 and 36 for the antenna to be built in the antenna case 100 can be inserted into the groove or the hole. Referring to FIG. 4A, grooves or holes for connecting an upper cap external antenna supporter 33, an upper cap external wall body supporter 34, and a lower cap external wall body supporter 37 are formed in the outer surface of the cap member 30 so that the antenna case 100 having the air hole structure is installed in an external structure such as a wall body or a ceiling.

As described above, in the antenna case 100 having the air hole structure according to an embodiment of the present invention, by the plurality of air holes 20 formed in the internal portion of the main body 10, durability of the main body 10 is improved, and the main body 10 becomes lightweight so that installation and maintenance are facilitated. In addition, the antenna case 100 having the air hole structure can be formed even using a single material, so that a unit price of a product is reduced resulting in improvement of productivity of the product.

Meanwhile, the antenna case 100 having the air hole structure according to an embodiment of the present invention is not limited to the above described embodiment, and antenna cases 200, 300, and 400 according to other embodiments in which a conductor rod 40 is inserted into the plurality of air holes 20 may be used.

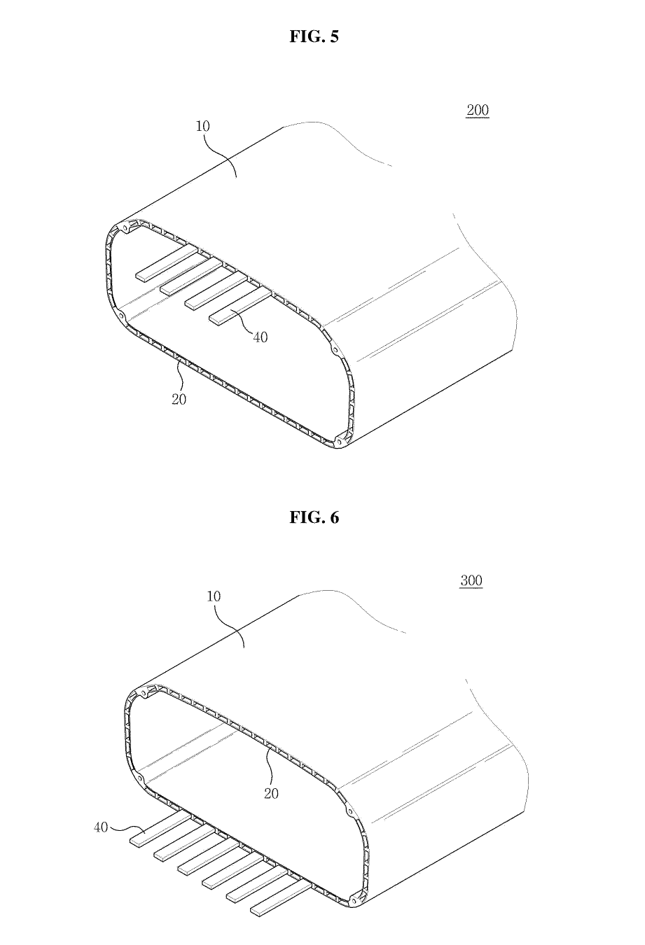

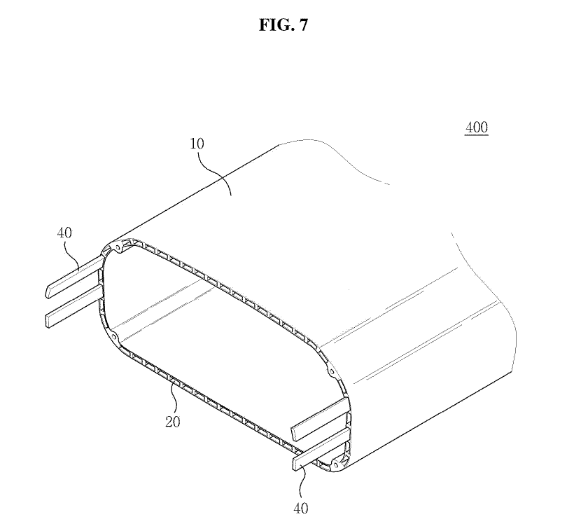

FIG. 5 is a perspective view showing an example in which a conductor rod 40 is inserted into an air hole 20 positioned in a front surface portion of a main body 10 of an antenna case 200 having an air hole structure according to another embodiment of the present invention, FIG. 6 is a perspective view showing an example in which a conductor rod 40 is inserted into an air hole 20 positioned in a rear surface portion of a main body 10 of an antenna case 300 having an air hole structure according to still another embodiment of the present invention, and FIG. 7 is a perspective view showing an example in which a conductor rod 40 is inserted into an air hole 20 positioned in a side surface portion of a main body 10 of an antenna case 400 having an air hole structure according to yet another embodiment of the present invention.

In the antenna cases 200, 300, and 400 having an air hole structure according other embodiments of the present invention, a plurality of conductor rods 40 are made of a conductor material and formed into a long rod shape so as to be inserted into the plurality of air holes 20. The conductor rods 40 are processed so as to conform to shapes and sizes of the air holes 20 so that the conductor rods 40 can be inserted into the air holes 20. In addition, the conductor rods 40 can be inserted into and removed from the air holes 20. When an antenna built in the main body 10 radiates radio waves at the time of insertion of the conductor rods 40, there are effects of improving a radiation pattern of the radio waves, a beam width, a front-to-back ratio, isolation, and the like. However, when the conductor rods 40 are inserted into the air holes 20, regular intervals therebetween should be maintained. As shown in FIG. 5, when the conductor rods 40 are inserted into the air holes 20 positioned in the front surface portion of the main body 10, there are effects such as horizontal beam adjustment of radio waves and beam width change (front repression or the like). As shown in FIG. 6, when the conductor rods 40 are inserted into the air holes 20 positioned in the rear surface portion of the main body 10, there is an effect of improvement of the front-to-back ratio of radio waves. In addition, as shown in FIG. 7, when the conductor rods 40 are inserted into the air holes 20 positioned in the side surface portion of the main body 10, there is an effect of improvement of horizontal beams of radio waves.

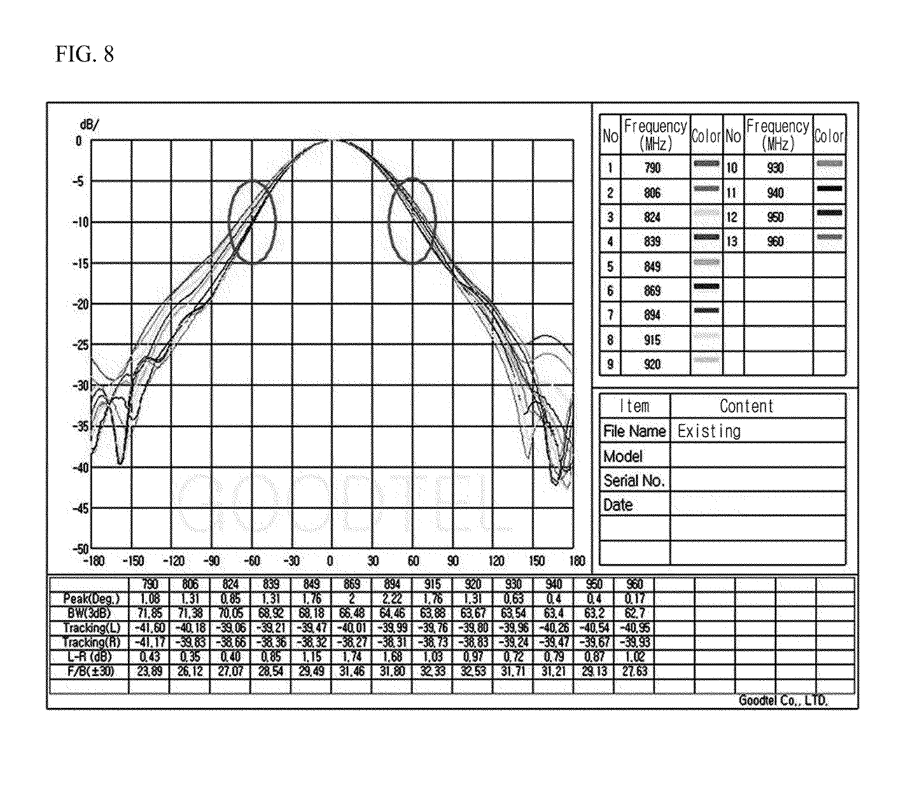

Hereinafter, electric characteristics of radio waves radiated by the radio wave transmission and reception device which is installed inside the antenna case 100 having the air hole structure according to the embodiments of the present invention will be described with reference to FIGS. 8 to 12.

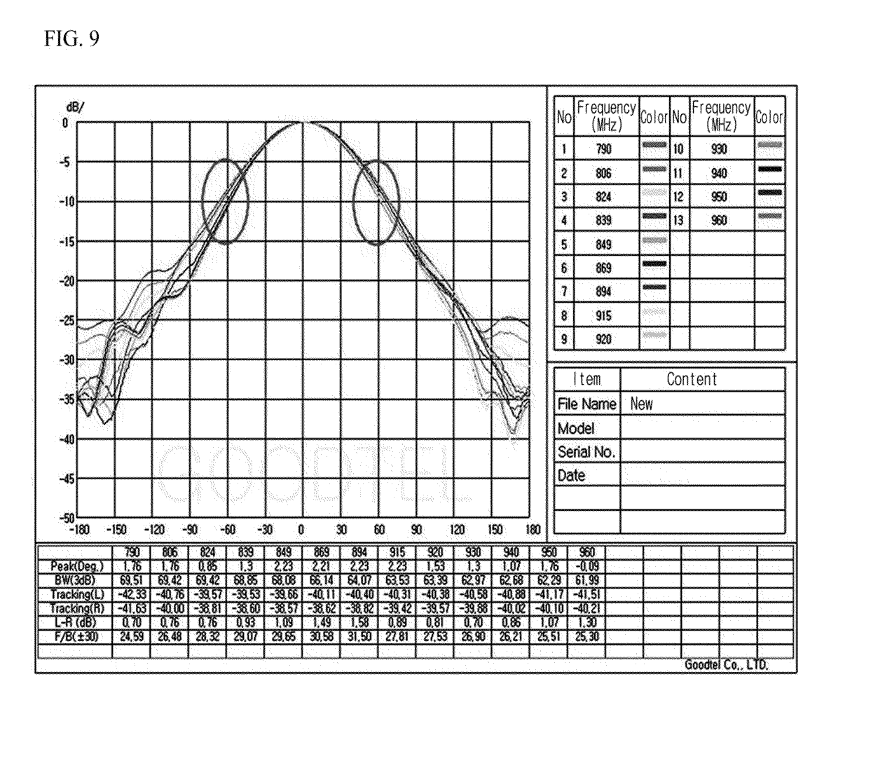

FIG. 8 is a graph showing a pattern of radio waves which are measured when using an antenna case used in a conventional repeater for mobile communication, and FIG. 9 is a graph showing a pattern of radio waves which are measured when using an antenna case having an air hole structure according to an embodiment of the present invention.

Referring to FIGS. 8 and 9, based on results obtained by comparing patterns of radio waves in a radio wave region of 790 MHz to 960 MHz, in changes in beam width (BW (3 dB)) of radio waves, constant radio wave pattern characteristics are shown compared to the related art when the antenna case having the air hole structure according to an embodiment of the present invention is installed.

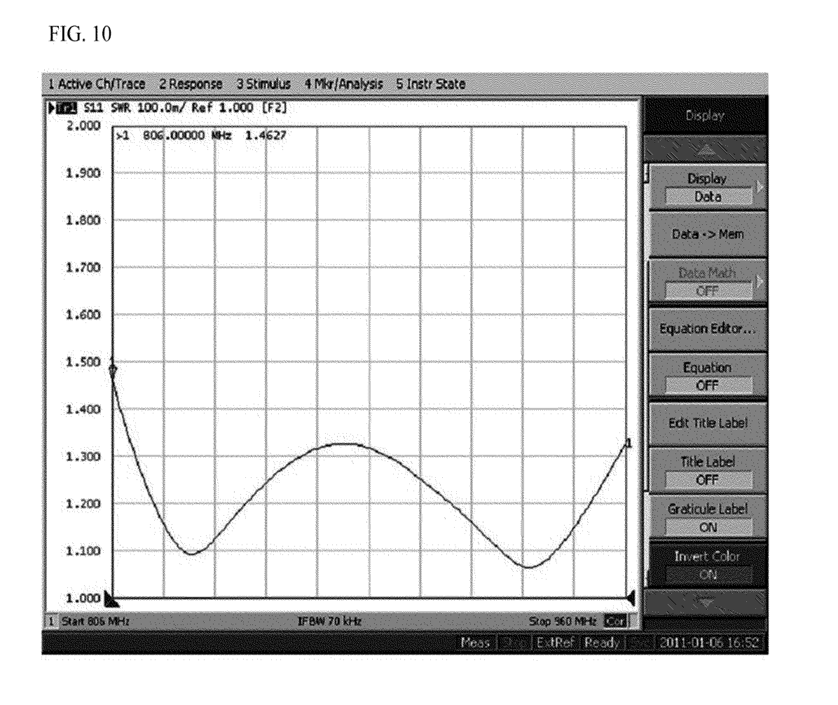

Meanwhile, changes in electric characteristics of radio waves caused by a dielectric constant of the material of the main body will be described with reference to FIGS. 10 to 12.

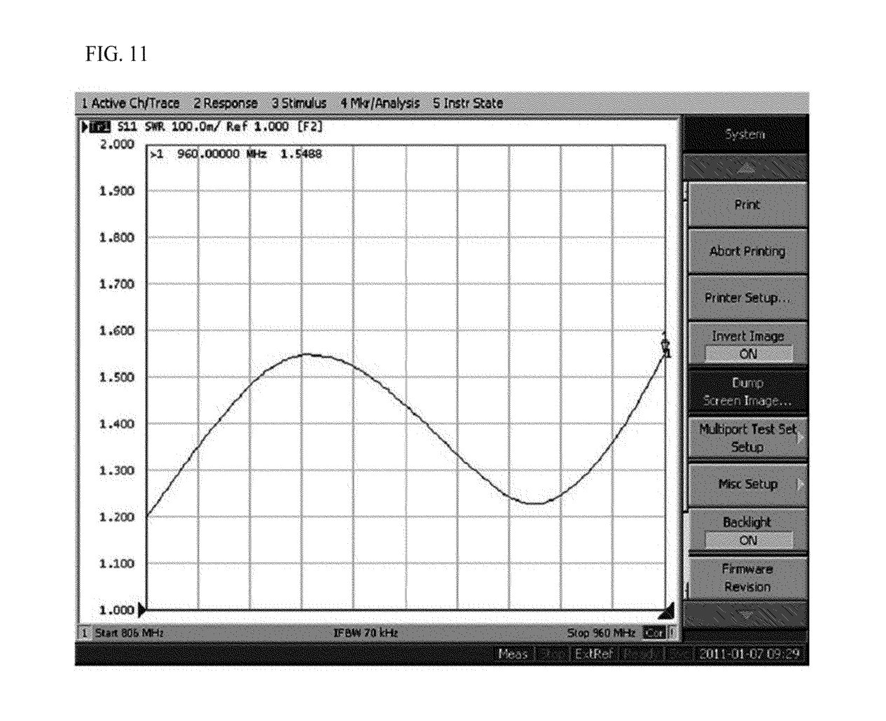

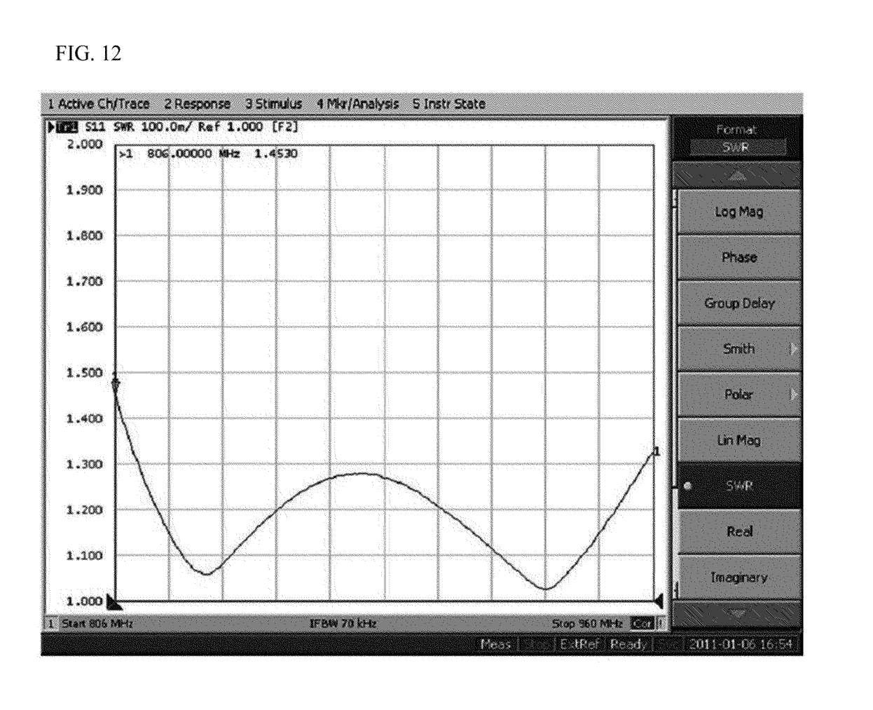

FIG. 10 is a graph showing a standing wave ratio of radio waves which are measured without covering an antenna case, FIG. 11 is a graph showing a standing wave ratio of radio waves which are measured when using a conventional antenna case, and FIG. 12 is a graph showing a standing wave ratio of radio waves which are measured when using an antenna case having an air hole structure according to an embodiment of the present invention.

Referring to FIGS. 10 to 12, the standing wave ratio of radio waves measured when using the conventional antenna case is transformed compared to the standing wave ratio of radio waves measured when not using the antenna case. However, the standing wave ratio of radio waves measured when using the antenna case having the air hole structure according to an embodiment of the present invention is similar to the standing wave ratio of radio waves measured when not using the antenna case.

Thus, the antenna case having the air hole structure according to the embodiments of the present invention reduces a beam width deviation for each frequency which is important to the electric characteristics of radio waves radiated from the antenna, and enables coverage to be maintained constantly, thereby stabilizing call quality. A distortion phenomenon of radio waves due to the dielectric constant of the synthetic resin is improved by the air hole structure, and therefore electric characteristics of radio waves when using the antenna case having the air hole structure are improved, thereby improving call quality.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An antenna case having an air hole structure comprising:
a main body which is formed into a tube shape to provide an installation space in which a radio wave transmission and reception device is installed, whose both distal ends are opened, and which includes a plurality of tubular air holes formed in an internal portion thereof; and
a pair of cap members which cover both opened portions of the main body.

2. The antenna case of claim 1, wherein the air holes are formed so as to correspond in a direction connecting both of the opened portions of the main body.

3. The antenna case of claim 1, wherein the main body is made of at least one synthetic resin, and is subjected to extrusion molding so as to form a structure of the plurality of air holes.

4. The antenna case of claim 1, further comprising:
at least one conductor rod which is inserted into at least one of the plurality of air holes.

5. The antenna case of claim 4, wherein the conductor rod is inserted into the air hole of a rear surface portion of the radio wave transmission and reception device to be installed inside the main body.

6. The antenna case of claim 4, wherein the conductor rod is inserted into the air hole of a front surface portion of the radio wave transmission and reception device to be installed inside the main body.

7. The antenna case of claim 4, wherein the conductor rod is inserted into the air hole of a side surface portion of the radio wave transmission and reception device to be installed inside the main body.

8. The antenna case of claim 5, wherein the conductor rod is inserted into the air hole of a side surface portion of the radio wave transmission and reception device to be installed inside the main body.

9. The antenna case of claim 6, wherein the conductor rod is inserted into the air hole of a side surface portion of the radio wave transmission and reception device to be installed inside the main body.
